(19) United States
(12) Patent Application Publication
(10) Pub. No.: US 2022/0234519 A1
(43) Pub. Date: Jul. 28, 2022

(54) VEHICLE EXTERIOR COMPONENT

(71) Applicant: TOYODA GOSEI CO., LTD., Kiyosu-shi (JP)

(72) Inventor: Kozo HIROTANI, Kiyosu-shi (JP)

(21) Appl. No.: 17/564,809

(22) Filed: Dec. 29, 2021

(30) Foreign Application Priority Data
Jan. 27, 2021 (JP) 2021-011316

(51) Int. Cl. B60R 13/00; H05B 3/28

(52) U.S. Cl. CPC B60R 13/005; H05B 2203/013; H05B 2203/003; H05B 3/286

(57) ABSTRACT

A vehicle exterior component includes a decorative main body and a heater sheet that includes a heating wire and a sheet base made of a plastic. The heating wire is routed on the back surface of the sheet base. The heater sheet includes a heating main body that is arranged to be closer to a front side than the decorative main body, and an extending portion that is bent along the outer circumference of the decorative main body to be arranged at a position closer to a back side than a front surface of the decorative main body. The extending portion includes a bent portion along the outer circumference. The wire length of the heating wire in the bent portion is set to a length that allows the heating wire to change shape to adapt to expansions and contractions of the sheet base in the bent portion.

### BACKGROUND

1. Field

The present disclosure relates to a vehicle exterior component that decorates a vehicle, such as an emblem, an ornament, or a mark.

2. Description of Related Art

A millimeter wave radar device installed in a vehicle transmits millimeter waves to the outside of the vehicle. The millimeter waves that hit, and are reflected by, an object outside the vehicle, such as a leading vehicle or a pedestrian, are received by the millimeter wave radar device. Based on the transmitted and received millimeter waves, the millimeter wave radar device recognizes the object and detects the distance and the relative velocity between the vehicle and the object.

The above-described vehicle includes a vehicle exterior component, such as an emblem, that is located forward of the millimeter wave radar device in the transmission direction of millimeter waves. The vehicle exterior component includes a decorative main body. The decorative main body conceals the millimeter wave radar device and is transmissive to millimeter waves.

When snow and ice collect on the ornamental surface (the front surface) of the vehicle exterior component, millimeter waves are attenuated, which reduces the detection performance of the millimeter wave radar device. In this regard, vehicle exterior components equipped with a snow melting function have been developed. For example, a heater sheet may be stacked on the front side of the decorative main body to provide a snow melting function.

The heater sheet includes a heating wire and a sheet base. The heating wire is configured to generate heat when energized. The heating wire is routed on the back surface of the sheet base. The heater sheet includes a heating main body and an extending portion. The heating main body is closer to the front side than the decorative main body. The extending portion extends from the periphery of the heating main body and is bent along the outer circumference of the decorative main body to be arranged at a position closer to the back side than the front surface of the decorative main body.

In the above-described vehicle exterior component, the heating wire generates heat when energized. Thus, when ice and snow collect on the ornamental surface (the front surface) of the vehicle exterior component, the heat generated by the heating wire melts the ice and snow, reducing attenuation of millimeter waves caused by collected ice and snow.

A typical example of a vehicle exterior component may include a technique for stacking a heater sheet on the front side of a decorative main body.

In the above-described typical vehicle exterior component, the extending portion of the heater sheet is stretched when being bent along the outer circumference of the decorative main body. Once the vehicle exterior component is installed in a vehicle, repeated changes in the ambient temperature may occur. When a section of the extending portion that has been stretched due to the bending action is expanded or contracted due to temperature changes, the heating wire may fail to adapt to expansions and contractions of the sheet base, and break.

Such a problem can occur not only in millimeter wave radar devices, but also in any type of vehicle exterior component that is installed in a vehicle equipped with a device that transmits and receives electromagnetic waves to detect an outside object, and includes a heater sheet on the front side of a decorative main body. Also, a phenomenon similar to the one described above can occur in a vehicle exterior component that is installed in a vehicle without a device that transmits and receives electromagnetic waves, but still includes a heater sheet on the front side of a decorative main body.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, a vehicle exterior component is provided that includes a decorative main body configured to decorate a vehicle, and a heater sheet that includes a heating wire and a sheet base made of a plastic. The heating wire is configured to generate heat when energized and is routed on a back surface of the sheet base. The heater sheet includes a heating main body and an extending portion. The heating main body is arranged to be closer to a front side than the decorative main body. The extending portion extends from a periphery of the heating main body and is bent along an outer circumference of the decorative main body to be arranged at a position closer to a back side than a front surface of the decorative main body. The extending portion includes a bent portion that is bent along the outer circumference. A wire length of the heating wire in the bent portion is set to a length that allows the heating wire to change a shape to adapt to expansions and contractions of the sheet base in the bent portion caused by changes in an ambient temperature.

In another aspect, a vehicle exterior component is provided that includes a decorative main body configured to decorate a vehicle, and a heater sheet that includes a heating wire and a sheet base made of a plastic. The heating wire is configured to generate heat when energized and is routed on a back surface of the sheet base. The heater sheet includes a heating main body and an extending portion. The heating main body is arranged to be closer to a front side than the decorative main body. The extending portion extends from a periphery of the heating main body and is bent along an outer circumference of the decorative main body to be arranged at a position closer to a back side than a front surface of the decorative main body. The extending portion includes a bent portion that is bent along the outer circumference. A direction in which the extending portion extends from the heating main body is referred to as an extending direction. An amount of change in the ambient temperature is represented by a temperature change amount ΔT. A difference between a linear thermal expansion coefficient of the sheet base and a linear thermal expansion coefficient of the heating wire is represented by a linear thermal expansion coefficient difference ΔA. A length of the bent portion in the extending direction is represented by an extending length Le. A wire length of the heating wire in the bent portion is represented by a wire length Lh. The wire length Lh satisfies a following Expression 1

Lh≤Le+ΔT×ΔA×Le (Expression 1).

Other features and aspects will be apparent from the following detailed description, the drawings, and the claims.

### BRIEF DESCRIPTION OF THE DRAWINGS

FIG. 1 is a front view of an emblem, which is a vehicle exterior component according to one embodiment.

FIG. 2 is a partial rear view illustrating a heater sheet according to the embodiment of FIG. 1.

FIG. 3 is a partial cross-sectional side view illustrating a lower structure of the emblem according to the embodiment of FIG. 1, together with part of a front grille and part of a millimeter wave radar device.

FIG. 4 is a cross-sectional view of a socket portion, taken along line 4-4 of FIG. 3.

FIG. 5 is a partial developed view of an extending portion of the heater sheet according to the embodiment of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle exterior component according to one embodiment will now be described with reference to the drawings. In the present embodiment, the vehicle exterior component is an emblem attached to a front portion of a vehicle.

In the following description, the direction in which the vehicle advances forward will be referred to as the front, and the reverse direction will be referred to as the rear. The vertical direction refers to the vertical direction of the vehicle, and the left-right direction refers to the vehicle width direction that agrees with the left-right direction when the vehicle is advancing forward. In the drawings, in order to make the size of each component recognizable, the scale of each component is altered as necessary.

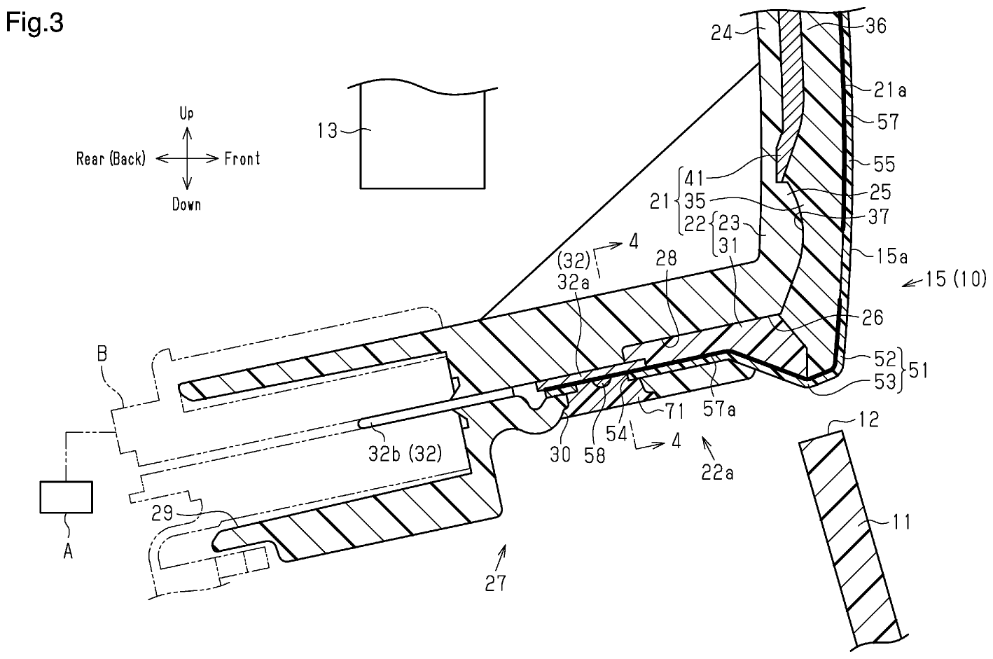

As shown in FIG. 3, a vehicle 10 is equipped with a front monitoring millimeter wave radar device 13 arranged at the front. The millimeter wave radar device 13 is located at the center in the left-right direction and behind a front grille 11. The millimeter wave radar device 13 transmits millimeter waves, which are included in electromagnetic waves, to the outside of the vehicle 10, specifically, toward the front, and receiving the millimeter waves that have struck and been reflected by an object outside the vehicle 10. Millimeter waves are radio waves with wavelengths of 1 mm to 10 mm and frequencies of 30 GHz to 300 GHz.

Like a typical front grille, the front grille 11 has an uneven thickness. The front grille 11 may include a plastic base with plating on the surface. The front grille 11 thus interferes with the transmitted or reflected millimeter waves. As such, the front grille 11 has a window 12, which is located in front of the millimeter wave radar device 13 in the transmission direction of the millimeter waves. FIG. 3 shows a lower part of the window 12.

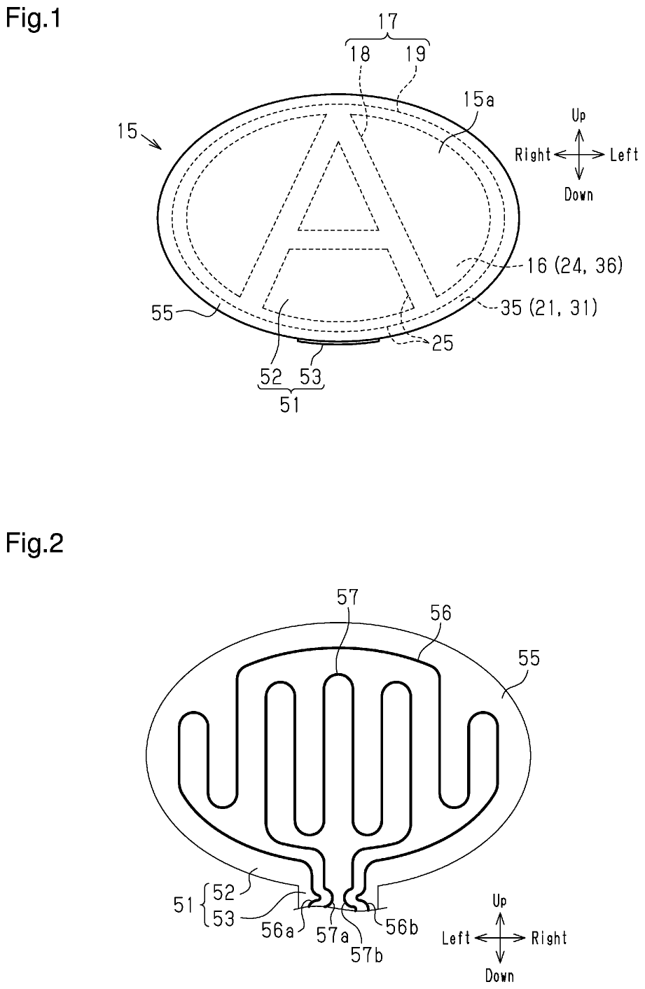

An emblem 15 is disposed in the window 12. The surface of the emblem 15 in the forward direction of the vehicle 10 (the surface on the right side as viewed in FIG. 3) includes an ornamental surface 15a. The outer shape of the ornamental surface 15a is horizontally oval (refer to FIG. 1). In the following description of the emblem 15, the side at which the ornamental surface 15a is disposed will be referred to as a front side, and the side opposite to the ornamental surface 15a (the left side as viewed in FIG. 3) will be referred to as a back side.

The emblem 15 is arranged in an upright state. In this arranged state, the front side in the emblem 15 corresponds to the front side of the vehicle 10, and the back side of the emblem 15 corresponds to the rear side in the vehicle 10.

Thus, in order to define directions corresponding to the front-rear direction of the vehicle 10, the words “front” and “back” will be used when the emblem 15 is described. The same applies to a case in which the emblem 15 attached to the vehicle 10 is described.

The emblem 15 includes a decorative main body 21 and a heater sheet 51. The components constituting the emblem 15 will now be described.

<Decorative Main Body 21>

As shown in FIGS. 1 and 3, the decorative main body 21 is arranged on the front side in the transmission direction of millimeter waves from the millimeter wave radar device 13 in the vehicle 10 to decorate the vehicle 10. The main portion of the decorative main body 21 is a plate having a horizontally oval shape in correspondence with the ornamental surface 15a of the emblem 15. Also, the main portion of the decorative main body 21 is transmissive to millimeter waves.

The decorative main body 21 includes a base 22, a transparent plastic layer 35, and a decorative layer 41. The base 22 is a component that constitutes the back-side portion of the decorative main body 21. The base 22 includes a base main body 23, which forms the framework, and a frame 31, which is provided in the outer circumference of the base main body 23.

The base main body 23 is made of a colored plastic of acrylonitrile-ethylene-styrene (AES) copolymer. The base main body 23 includes a general portion 24 and a protrusion 25 on the front side. The general portion 24 is nearly orthogonal to the front-rear direction and substantially flat. The protrusion 25 protrudes forward from the general portion 24. The general portion 24 corresponds to a background area 16 of the emblem 15 as viewed in FIG. 1. The protrusion 25 corresponds to a pattern area 17 of the emblem 15. In the present embodiment, the pattern area 17 is formed by a letter 18, which is “A” and an annular portion 19 surrounding the letter 18.

As shown in FIG. 3, the base main body 23 includes an annular recess 26 in the outer circumference. The annular recess 26 is open in the surface on the front side of the base main body 23 and is recessed toward the back side. The annular recess 26 has an annular oval shape corresponding to the periphery of the base main body 23.

The base 22 includes a socket 27 in a lower portion. The socket 27 protrudes backward. The socket 27 is configured to receive a plug B of a device A for supplying power. The socket 27 includes a recess 28 in the front side. The recess 28 extends toward the back from the annular recess 26. Further, the socket 27 includes a recess 29, which is open in the back surface of the socket 27 and is recessed toward the front side.

In place of AES plastic, the base main body 23 may be made of, for example, acrylonitrile-styrene-acrylate (ASA) plastic, polycarbonate (PC) plastic, and a polymer alloy of PC plastic and acrylonitrile-butadiene-styrene (ABS) copolymer.

The frame 31 is provided along the outer circumference of the base main body 23 so as to have an annular oval shape (refer to FIG. 1). Most of the frame 31 is formed to fill the annular recess 26. Part of the lower portion of the frame 31 is formed to fill the recess 28 of the socket 27. The frame 31 is made of black plastic that is a mixture of PC plastic and carbon black.

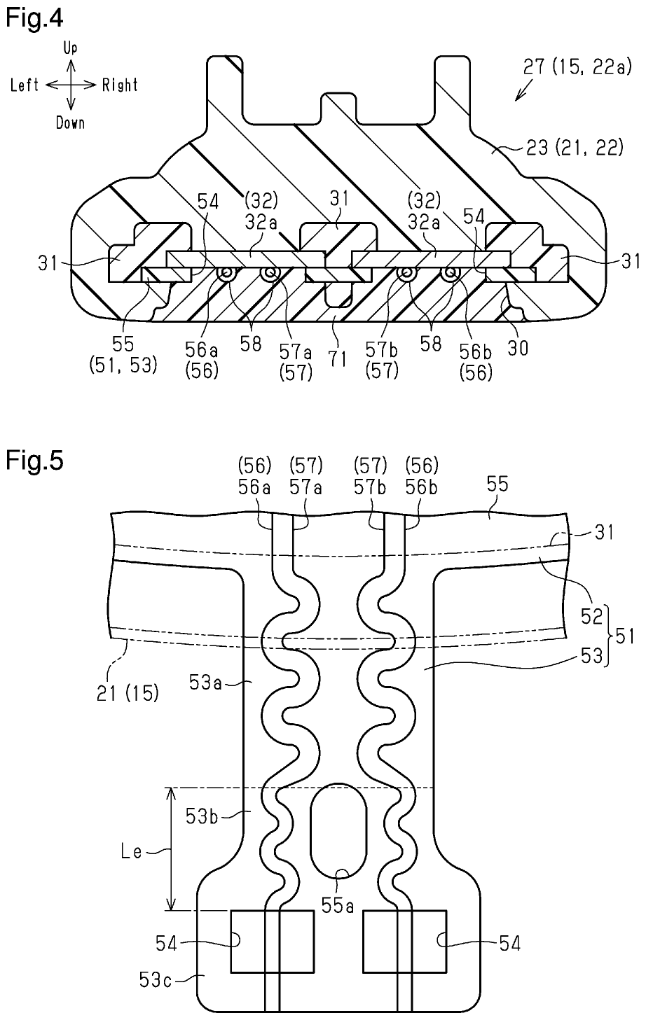

As shown in FIGS. 3 and 4, two connector pins 32, which extend in the front-rear direction, are provided in the socket 27. The connector pins 32 are spaced apart from each other in the left-right direction. Each connector pin 32 includes a front-side portion 32a, which has a shape of a flat plate. The front-side portions 32a are embedded in the base main body 23 and the frame 31. Also, each connector pin 32 includes a rod-shaped back-side portion 32b. The back-side portions 32b are partially arranged in the recess 29.

The base 22 includes a window 30 in an outer circumference 22a. The window 30 is located in the lower portion of the socket 27 and opens in the lower surface of the socket 27. The window 30 is provided to allow the heating wires 56, 57, which will be discussed below, to be joined to the connector pins 32.

The base 22 (the base main body 23) includes attachment portions (not shown) at several positions along the periphery of the back surface. The attachment portions are used to attach the emblem 15 to the front grille 11 or the vehicle body. The attachment portions include, for example, clips, screws, or engaging hooks.

As shown in FIGS. 1 and 3, the transparent plastic layer 35 is the front-side portion of the main part of the decorative main body 21. The transparent plastic layer 35 is made of a transparent PC plastic. The term “transparent” as used in this description includes not only “colorless transparent,” but also “colored transparent.” The same applies to a sheet base 55, which will be discussed below. The back-side portion of the transparent plastic layer 35 has a shape that corresponds to the shape of the front-side portion of the base main body 23. That is, the transparent plastic layer 35 includes a general portion 36 on the back-side portion, which corresponds to the front side of the general portion 24 of the base main body 23. The general portion 36 is nearly orthogonal to the front-rear direction and substantially flat. The transparent plastic layer 35 includes a recess 37 on the back-side portion, which corresponds to the front side of the protrusion 25 of the base main body 23. The recess 37 is recessed toward the front side with respect to the general portion 36. The outer circumference of the transparent plastic layer 35 is located on the front side of the frame 31. In place of PC plastic, the transparent plastic layer 35 may be made of a transparent plastic, such as polymethyl methacrylate (PMMA).

The decorative layer 41 is provided in an area between the base main body 23 and the transparent plastic layer 35 surrounded by the frame 31. Also, the decorative layer 41 is transmissive to millimeter waves. The decorative layer 41 is composed by combining a colored decorative layer, which has a deep color such as black or blue, and a luster decorative layer, which is made of metal such as indium (In).

In the decorative main body 21, the frame 31 is welded to the base main body 23 and the transparent plastic layer 35, so as to connect the base main body 23 and the transparent plastic layer 35 to each other.

The area in the decorative main body 21 through which millimeter waves pass has a uniform thickness.

<Heater Sheet 51>

As shown in FIGS. 2 and 3, the heater sheet 51 includes the sheet base 55 and the two heating wires 56, 57. The sheet base 55 is made of a transparent plastic such as PC plastic. The heating wires 56, 57 are made of a metal that generates heat when energized, and are routed on the back surface of the sheet base 55.

The heater sheet 51 includes a heating main body 52 and an extending portion 53. The extending portion 53 extends from the periphery of the heating main body 52, specifically, from the lower edge of the heating main body 52 in the present embodiment. The direction in which the extending portion 53 extends from the heating main body 52 is referred to as an extending direction of the extending portion 53. A direction along the surface of the extending portion 53 and orthogonal to the extending direction is referred to as a width direction of the extending portion 53. The heating main body 52 has a shape of a horizontally oval plate in correspondence with the ornamental surface 15a of the emblem 15. The heating main body 52 is stacked on the front side of the transparent plastic layer 35 of the decorative main body 21. In the heating main body 52, the heating wires 56, 57 are routed in different patterns (refer to FIG. 2).

As shown in FIG. 3, the extending portion 53 is bent along the lower surface of the transparent plastic layer 35 and the lower surface of the frame 31, so as to be put around the lower end of the outer circumference of the decorative main body 21 and reach the back side of a front surface 21a of the decorative main body 21. In order to distinguish sections in the extending portion 53, the section that is bent in the above-described manner is referred to as a bent portion 53b as shown in FIG. 5. The bent portion 53b is an area extending in the extending direction between the broken line in FIG. 5 and openings 54, which will be discussed below. A section in the extending portion 53 between the heating main body 52 and the bent portion 53b is referred to as an extending front portion 53a. A section in the extending portion 53 on a side of the bent portion 53b opposite to the extending front portion 53a, in other words, a section closer to the back side than the bent portion 53b, is referred to as an extending back portion 53c.

The bent portion 53b has a stadium-shaped insertion hole 55a, which extends in the extending direction, in the center in the width direction. Also, although not illustrated, the decorative main body 21 has an attachment boss at a position that corresponds to the insertion hole 55a. When the heater sheet 51 is attached to the decorative main body 21, the attachment boss is inserted into the insertion hole 55a, so that the extending portion 53 and thus the heater sheet 51 are positioned in relation to the decorative main body 21.

The extending back portion 53c has the openings 54 in the sides in the width direction. The openings 54 are spaced apart from each other in the width direction. In the present embodiment, the openings 54 are rectangular. However, the openings 54 may have another shape.

As shown in FIGS. 2, 4, and 5, the two heating wires 56, 57 are routed not only in the heating main body 52, but also in the extending portion 53. That is, the heating wire 56 has terminals 56a, 56b at the opposite ends. The heating wire 57 has terminals 57a, 57b at the opposite ends. The terminals 56a, 57a are arranged on the back surface of the extending portion 53 and closely arranged at one side in the width direction. The terminals 56a, 57a have the same polarity. The terminals 56b, 57b are arranged on the back surface of the extending portion 53 and closely arranged at the other side in the width direction. The terminals 56b, 57b have the same polarity that is different from the polarity of the terminals 56a, 57a.

As shown in FIG. 5, the terminals 56a, 57a and the terminals 56b, 57b are routed in the same manner (in an axisymmetrical manner). Therefore, in the following description, only the terminals 56a, 57a will be described, and the illustration of the terminals 56b, 57b will be omitted.

The terminals 56a, 57a are routed in different patterns between the extending back portion 53c and the region including the extending front portion 53a and the bent portion 53b. The terminals 56a, 57a are routed to extend linearly in the extending direction in the extending back portion 53c. Parts of the terminals 56a, 57a cross the openings 54 in the extending direction.

The sections of the terminals 56a, 57a in the bent portion 53b are set to have lengths that allow the terminals 56a, 57a to change their shapes to adapt to expansions and contractions of the sheet base 55 in the bent portion 53b caused by changes in the ambient temperature.

The amount of change in the ambient temperature is represented by a temperature change amount ΔT. The difference between the linear thermal expansion coefficient of the sheet base 55 and the linear thermal expansion coefficient of the heating wires 56, 57 is represented by a linear thermal expansion coefficient difference ΔA. The length of the bent portion 53b in the extending direction is represented by an extending length Le. The length of the sections of the terminals 56a, 57a in the bent portion 53b is represented by a wire length Lh.

The wire length Lh is set to satisfy the following Expression 1.

Lh≥Le+ΔT×ΔA×Le (Expression 1)

Specifically, the terminals 56a, 57a are routed in wavy patterns that advance in the extending direction while oscillating to opposite sides in the width direction in the region including the bent portion 53b and the extending front portion 53a. The bent portion 53b has the insertion hole 55a as described above. With respect to the extending direction, the section of the bent portion 53b that includes the insertion hole 55a has a net dimension in the width direction that is smaller than the dimension of the extending front portion 53a. Accordingly, the terminals 56a, 57a have oscillating pattern in the width direction with a smaller amplitude in the bent portion 53b than in the extending front portion 53a.

In the present embodiment, the wire length Lh is set to a value greater than or equal to 1.04 times the extending length Le. This setting allows the terminals 56a, 57a to change shape to adapt to expansions and contractions of the sheet base 55 in the bent portion 53b caused by changes in the ambient temperature, even if variations in the shape and size of the emblem 15 are maximal in possible ranges.

Further, sections of the terminals 56a, 57a that are located at the boundary between the extending portion 53 (the extending front portion 53a) and the heating main body 52 are located on the front side of the frame 31.

As shown in FIGS. 3 and 4, a section of the extending portion 53 that reaches the back side via the lower end of the outer circumference of the decorative main body 21 is arranged between the frame 31 and the inner wall surface of the recess 28.

A section of the extending portion 53 that surrounds the openings 54 is stacked on part of the front-side portion 32a of each connector pin 32 from the front side (the outer circumference). The terminals 56a, 57a are joined to the front-side portion 32a of one of the connector pins 32 by performing welding in one of the openings 54. Likewise, the terminals 56b, 57b are joined to the front-side portion 32a of the other connector pin 32 by performing welding in the other opening 54. In FIGS. 3 and 4, the reference numerals 58 denote joint portions that are made of a solder alloy and formed by soldering. The joint portions 58 electrically connect the terminals 56a, 56b and the terminals 57a, 57b to the front-side portions 32a of the connector pins 32 in the outer circumference 22a of the base 22.

The above-described joining does not necessarily need to be performed by soldering, but may be performed by welding, crimping, or adhesion using an electrically conductive adhesive.

The sections at which the terminals 56a, 56b and the terminals 57a, 57b are joined to the connector pins 32 by the joint portions 58 are referred to as joint sections. A water stop portion 71, which restricts entry of water into the joint sections, is provided in the window 30. The water stop portion 71 is formed by filling the window 30 with plastic.

The emblem 15, which has the above-described configuration, is disposed in the window 12 while being set vertical as shown in FIG. 3 and attached to the front grille 11 or the vehicle body at the attachment portions.

Further, the plug B of the device A is inserted into the recess 29 of the socket 27 from the back side of the emblem 15, so that the heating wires 56, 57 are electrically connected to the device A.

Operation of the above-described embodiment will now be described. Advantages that accompany the operation will also be described.

At the time of manufacture of the emblem 15 according to the present embodiment, the bent portion 53b of the extending portion 53 of the heater sheet 51 is bent along the outer circumference of the decorative main body 21 as shown in FIGS. 3 and 5. At this time, the bent portion 53b is stretched in the extending direction of the extending portion 53.

Therefore, after the emblem 15, which has been manufactured with the bent portion 53b in a stretched state as described above, is attached to the vehicle 10, repeated changes in the ambient temperature expand and contract the bent portion 53b of the extending portion 53, which was stretched through the bending operation.

If the terminals 56a, 56b of the heating wire 56 and the terminals 57a, 57b of the heating wire 57 extend linearly in the extending direction in the bent portion 53b, the following drawbacks may be caused. That is, if the bent portion 53b is expanded or contracted through changes in the temperature, the terminals 56a, 56b and the terminals 57a, 57b may fail to adapt to expansion and contraction of the sheet base 55. In this case, the terminals 56a, 56b and the terminals 57a, 57b in a maximally stretched state may be broken by being pulled excessively.

In this regard, in the present embodiment, as shown in FIG. 5, the terminals 56a, 56b and the terminals 57a, 57b are routed in wavy patterns that advance in the extending direction while oscillating in the width direction of the extending portion 53 in the bent portion 53b of the extending portion 53. This routing allows the wire length Lh to satisfy the relationship represented by the Expression 1. This setting allows the terminals 56a, 56b and the terminals 57a, 57b to have lengths that allow for changes in shape so as to adapt to expansions and contractions of the sheet base 55 in the bent portion 53b caused by changes in the ambient temperature.

Since the heating wires 56, 57 change shape to adapt to expansions and contractions of the sheet base 55 in the bent portion 53b, the terminals 56a, 56b and the terminals 57a, 57b are allowed to expand and contract in the extending direction. Thus, in the present embodiment, repeated changes in the ambient temperature will not maximally stretch the terminals 56a, 56b and the terminals 57a, 57b in the extending direction. Also, the terminals 56a, 56b and the terminals 57a, 57b in a maximally stretched state will not be pulled excessively in the extending direction. This prevents the terminals 56a, 56b and the terminals 57a, 57b from being broken in the bent portion 53b.

When ice and snow collect on the ornamental surface 15a of the emblem 15, power is supplied to the heating wires 56, 57 via the plug B of the device A and the connector pins 32 as shown in FIGS. 2 and 3. The heating wires 56, 57 are thus energized to generate heat. Some of the heat generated by the heating wires 56, 57 is transferred to the ornamental surface 15a of the emblem 15. The transferred heat melts the ice and snow collected on the ornamental surface 15a, thereby reducing the attenuation of millimeter waves caused by ice and snow.

Particularly, the heater sheet 51 is located in the forefront section in the emblem 15 in the present embodiment. This allows the heat generated by the heating wires 56, 57 to be readily transferred to the ornamental surface 15a (the front surface) of the emblem 15, so that ice and snow are melt efficiently.

Millimeter waves transmitted by the millimeter wave radar device 13 pass through, in the order, the base main body 23, the decorative layer 41, and the transparent plastic layer 35 in the decorative main body 21 of the emblem 15, and the heating main body 52 of the heater sheet 51. After passing through these components, the millimeter waves hit and are reflected by an object in front of the vehicle, such as a leading vehicle or a pedestrian, and then pass through, in the order, the heating main body 52 of the heater sheet 51, and the transparent plastic layer 35, the decorative layer 41, and the base main body 23 in the decorative main body 21. After passing through the decorative main body 21, the millimeter waves are received by the millimeter wave radar device 13. Based on the transmitted and received millimeter waves, the millimeter wave radar device 13 recognizes the object and detects the distance and the relative velocity between the vehicle 10 and the object.

When the emblem 15 is irradiated with visible light from ahead of the vehicle 10, the visible light passes through the heating main body 52 of the heater sheet 51 and the transparent plastic layer 35 of the decorative main body 21, and is reflected by the decorative layer 41. When the emblem 15 is seen from ahead of the vehicle 10, the decorative layer 41 appears to be located behind (farther than) the heating main body 52 and the transparent plastic layer 35. The decorative layer 41 thus decorates the emblem 15, improving the appearance of the emblem 15 and the surrounding portion.

The reflection of visible light on the decorative layer 41 occurs at a position forward of the millimeter wave radar device 13. The decorative layer 41 conceals the millimeter wave radar device 13. Accordingly, the millimeter wave radar device 13 cannot be seen easily from ahead of the emblem 15. The appearance is thus improved as compared with a case in which the millimeter wave radar device 13 can be seen through the emblem 15.

In addition to the ones listed above, the present embodiment has the following advantages.

In the present embodiment, as shown in FIGS. 3 and 4, one of the connector pins 32 and the terminals 56a, 57a are joined to each other in the outer circumference 22a of the base 22. Also, the other connector pin 32 and the terminals 56b, 57b are joined to each other in the outer circumference 22a. The joint sections are covered with the outer circumference 22a. The joint sections thus do not degrade the appearance as compared to a case in which joining is performed on the front side of the transparent plastic layer 35.

In the present embodiment, the terminals 56a, 56b and the terminals 57a, 57b are routed in wavy patterns in the extending front portion 53a as shown in FIG. 5. Thus, as in the case of the bent portion 53b, since the heating wires 56, 57 change shape to adapt to expansions and contractions of the sheet base 55 in the extending front portion 53a, the terminals 56a, 56b and the terminals 57a, 57b are allowed to expand and contract in the extending direction. This further effectively prevents the terminals 56a, 56b and the terminals 57a, 57b from being broken, even if the ambient temperature changes repeatedly.

The terminals 56a, 56b and the terminals 57a, 57b are routed in wavy patterns in the boundary between the extending front portion 53a and the heating main body 52, and the wavy sections are located on the front side of the black frame 31. Accordingly, the wavy sections cannot be seen easily from the outside of the vehicle 10.

Further, the bent portion 53b is closer to the back side than the transparent plastic layer 35 as shown in FIG. 3. Thus, although the terminals 56a, 56b and the terminals 57a, 57b are routed in wavy patterns in the bent portion 53b, these wavy sections cannot be seen easily from the outside of the vehicle 10.

Therefore, the appearance is prevented from being degraded by sections of the heating wires 56, 57 in which wavy patterns are visible from the outside of the vehicle 10.

The above-described embodiment may be modified as follows. The above-described embodiment and the following modifications can be combined as long as the combined modifications remain technically consistent with each other.

The number of the heating wires 56, 57 in the heater sheet 51 may be changed to one or a number greater than two.

The extending portion 53 may extend from a position different from the lower edge of the periphery of the heating main body 52, for example, from the upper edge or a side end.

The outer shape of the ornamental surface 15a of the emblem 15 may be changed to a shape that is different from a horizontally oval shape.

The terminals 56a, 56b and the terminals 57a, 57b in the bent portion 53b may be routed in a pattern different from that in the above-described embodiment, for example, in a zigzag pattern. The same modification may be applied to the extending front portion 53a.

The terminals 56a, 56b and the terminals 57a, 57b in the extending front portion 53a may be routed to extend linearly in the extending direction.

The above-described embodiment may be applied to any vehicle exterior component that is installed in a vehicle equipped with a device that transmits and receives electromagnetic waves to detect an outside object, and includes a heater sheet on the front side of a decorative main body. In this case, the electromagnetic waves transmitted and received by the device include millimeter waves and infrared rays.

The device that transmits and receives electromagnetic waves to detect an outside object is not limited to a front monitoring device, but may be a device that monitors the situation behind the vehicle, the situation on the sides of the front part of the vehicle, or the situation on the sides of the rear part of the vehicle. In these cases, the vehicle exterior component is located forward of the device in the transmission direction of millimeter waves.

The above-described vehicle exterior component may be installed in a vehicle that is not equipped with a device that transmits and receives electromagnetic waves to detect an outside object.

In addition to an emblem, the above-described embodiment may be applied to a vehicle exterior component that decorates a vehicle, such as an ornament and a mark.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a decorative main body configured to decorate a vehicle; and
a heater sheet that includes a heating wire and a sheet base made of a plastic, wherein
the heating wire is configured to generate heat when energized and is routed on a back surface of the sheet base,
the heater sheet includes:
a heating main body that is arranged to be closer to a front side than the decorative main body; and
an extending portion that extends from a periphery of the heating main body and is bent along an outer circumference of the decorative main body to be arranged at a position closer to a back side than a front surface of the decorative main body,
the extending portion includes a bent portion that is bent along the outer circumference, and
a wire length of the heating wire in the bent portion is set to a length that allows the heating wire to change a shape to adapt to expansions and contractions of the sheet base in the bent portion caused by changes in an ambient temperature.

2. The vehicle exterior component according to claim 1, wherein
a direction in which the extending portion extends from the heating main body is referred to as an extending direction,
an amount of change in the ambient temperature is represented by a temperature change amount ΔT,
a difference between a linear thermal expansion coefficient of the sheet base and a linear thermal expansion coefficient of the heating wire is represented by a linear thermal expansion coefficient difference ΔA,
a length of the bent portion in the extending direction is represented by an extending length Le,
the wire length of the heating wire in the bent portion is represented by a wire length Lh, and
the wire length Lh satisfies a following Expression 1
Lh≥Le+ΔT×ΔA×Le (Expression 1).

3. The vehicle exterior component according to claim 2, wherein the wire length Lh of the heating wire is set to a value greater than or equal to 1.04 times the extending length Le.

4. The vehicle exterior component according to claim 2, wherein
a direction along a surface of the extending portion and orthogonal to the extending direction is referred to as a width direction of the extending portion, and
in the bent portion, the heating wire is routed in a wavy pattern that advances in the extending direction while oscillating to opposite sides in the width direction.

5. A vehicle exterior component, comprising:
a decorative main body configured to decorate a vehicle; and
a heater sheet that includes a heating wire and a sheet base made of a plastic, wherein
the heating wire is configured to generate heat when energized and is routed on a back surface of the sheet base,
the heater sheet includes:
a heating main body that is arranged to be closer to a front side than the decorative main body; and
an extending portion that extends from a periphery of the heating main body and is bent along an outer circumference of the decorative main body to be arranged at a position closer to a back side than a front surface of the decorative main body,
the extending portion includes a bent portion that is bent along the outer circumference, and
a direction in which the extending portion extends from the heating main body is referred to as an extending direction,
an amount of change in the ambient temperature is represented by a temperature change amount ΔT,
a difference between a linear thermal expansion coefficient of the sheet base and a linear thermal expansion coefficient of the heating wire is represented by a linear thermal expansion coefficient difference ΔA,
a length of the bent portion in the extending direction is represented by an extending length Le,
a wire length of the heating wire in the bent portion is represented by a wire length Lh, and
the wire length Lh satisfies a following Expression 1
Lh≥Le+ΔT×ΔA×Le (Expression 1).

6. The vehicle exterior component according to claim 5, wherein the wire length Lh of the heating wire is set to a value greater than or equal to 1.04 times the extending length Le.

7. The vehicle exterior component according to claim 5, wherein
a direction along a surface of the extending portion and orthogonal to the extending direction is referred to as a width direction of the extending portion, and
in the bent portion, the heating wire is routed in a wavy pattern that advances in the extending direction while oscillating to opposite sides in the width direction.
